(19) United States
(12) Patent Application Publication
(10) Pub. No.: US 2014/0207263 A1
(43) Pub. Date: Jul. 24, 2014

(54) EVALUATING A FITNESS LEVEL

(71) Applicants: David B. Patzwald, Dallas, TX (US); George M. Maney, Dallas, TX (US)

(72) Inventors: David B. Patzwald, Dallas, TX (US); George M. Maney, Dallas, TX (US)

(21) Appl. No.: 13/747,984

(22) Filed: Jan. 23, 2013

(51) Int. Cl. G06F 17/40

(52) U.S. Cl. CPC G06F 17/40
USPC 700/91

(57) ABSTRACT

A system for determining fitness level includes an electronic interface operable to receive an event performance measurement for each of a plurality of athletic events, a processor communicatively coupled to the electronic interface and operable to associate one or more fitness categories with each of the plurality of athletic events, determine an event performance score for each received event performance measurement, calculate a fitness category score for each of the plurality of fitness categories, wherein each fitness category score is based on one or more of the event performance scores, and calculate a total fitness score based on the calculated fitness category scores, and the electronic interface further operable to communicate the calculated total fitness score over an electronic communication network.

### TECHNICAL FIELD OF THE INVENTION

This invention relates generally to personal fitness, and specifically to evaluating a fitness level of an individual.

### BACKGROUND OF THE INVENTION

There are a number of ways to evaluate fitness, however, it is often difficult to evaluate fitness across a broad spectrum of fitness categories. For example, a marathon runner is fit in different fitness categories than a weight lifter. Because of different fitness types, it is also difficult to compare the fitness levels of different types of athletes.

### SUMMARY OF THE INVENTION

According to embodiments of the present disclosure, disadvantages and problems associated with determining fitness levels may be reduced or eliminated.

A system for determining fitness level includes an electronic interface operable to receive an event performance measurement for each of a plurality of athletic events, a processor communicatively coupled to the electronic interface and operable to associate one or more fitness categories with each of the plurality of athletic events, determine an event performance score for each received event performance measurement, calculate a fitness category score for each of the plurality of fitness categories, wherein each fitness category score is based on one or more of the event performance scores, and calculate a total fitness score based on the calculated fitness category scores, and the electronic interface further operable to communicate the calculated total fitness score over an electronic communication network.

Certain embodiments of the present disclosure may include some, all, or none of the following advantages. One or more other technical advantages may be readily apparent to those skilled in the art from the figures, descriptions, and claims included herein.

In an embodiment, a system for evaluating a fitness level allows users to determine a fitness level using an electronic communication network, thereby reducing the time and cost required to determine a fitness level.

In an embodiment, a system for evaluating a fitness level automatically updates performance scales based on event performance data received from users, thereby reducing the bandwidth, memory, and computing resources consumed by manually researching event performance data and manually updating performance scales.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 is a block diagram of an example embodiment of a system for evaluating a fitness level;

FIG. 2 is a chart of an example embodiment of athletic events and corresponding fitness categories;

FIG. 3 is a graph of an example embodiment of a performance scale for converting event performance measurements to event performance scores; and

FIG. 4 is a diagram illustrating an example embodiment of fitness category scores and total fitness scores for two different types of athlete.

### DETAILED DESCRIPTION OF THE INVENTION

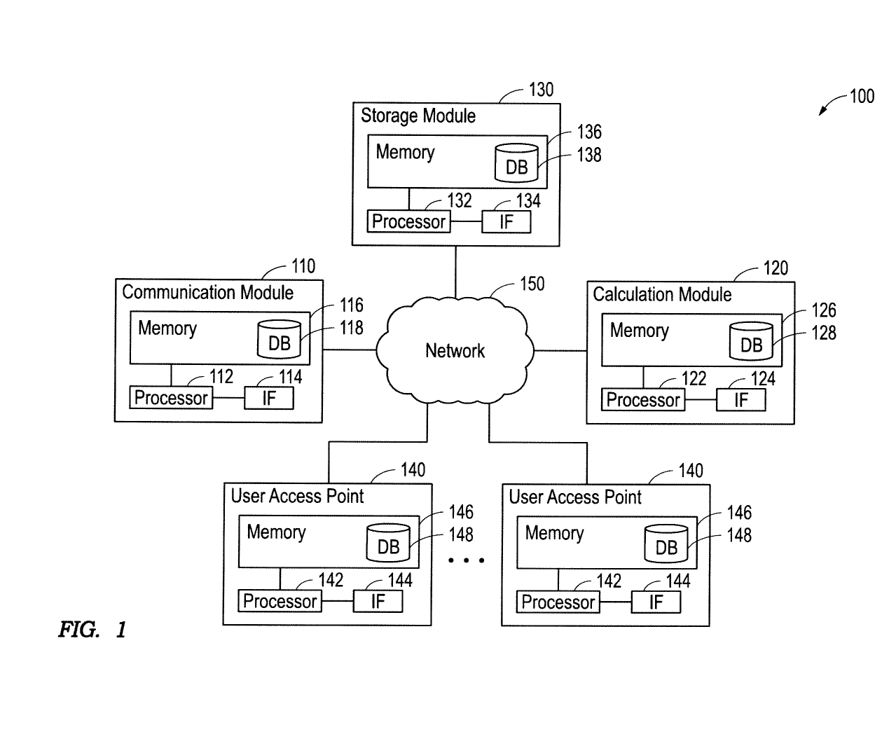

Embodiments of the present invention and its advantages are best understood by referring to FIGS. 1 through 4 of the drawings, like numerals being used for like and corresponding parts of the various drawings.

In an example, a system for evaluating a fitness level includes one or more of a communication module, a calculation module, a storage module, a user access point, and a network. The communication module provides instructional information describing how to perform and measure a plurality of pre-defined athletic events to user access points over the network, for example, through a website or other suitable communication platform. From the instructional information, users can perform the athletic events and measure their performance in each event. The predetermined athletic events may include any suitable athletic activity, for example, a timed 400 meter run, a timed 40 yard run, a timed 5 kilometer run, a timed 60 yard shuttle run, a maximum number of squat thrusts and jumps in a time period, a measured standing broad jump distance, a measured overhead medicine ball throw distance, a maximum number of pushups, a maximum bench press weight, a maximum time plank position hold, a maximum number of pullups, a maximum squat press weight, and a maximum time wall squat. Each of the pre-defined athletic events are associated with at least one or more fitness categories, for example, muscular strength, muscular endurance, cardiovascular endurance, speed, agility, and power.

Users can communicate athletic event measurements to the system using a user access point, for example, by submitting their athletic event performance scores through the website. User access points include any suitable electronic communication device operable to access an electronic communication network (e.g., computers, smart phones, tablets, etc.). Certain user access points are certified user access points. Certified user access points represent user access points that are associated with particular classes of users. For example, a user that has been specially trained in proper administration of athletic events and measuring athletic events can communicate certified athletic performance measurements to system 100.

The communication module receives the event performance measurements from users and stores them in a storage module. The calculation module determines an event performance score for each event performance measurement. For example, calculation module may determine that an event performance measurement of 4.82 seconds for the 40 yard run has an event performance score of 75 points out of a possible 100 points. The event performance score determined by the event performance measurements may be scaled such that the relationship between the event performance measurement and the event performance score is non-linear. The calculation module determines one or more fitness category scores from the determined event performance scores. For example, each fitness category score may be based on one or more event performance scores associated with the fitness category. Certain events may be weighted heavier than others in determining a fitness category score. For example, a fitness category associated with three athletic events may weight the first event as 50% of the fitness category score, the second event as 35% of the fitness category score, and the third event as 15% of the fitness category score. The calculation module can determine a total fitness score based on the determined fitness category scores.

FIG. 1 is a block diagram of an example embodiment of a system 100 for evaluating a fitness level. According to an embodiment, system 100 includes communication module 110, calculation module 120, storage module 130, user access points 140, and network 150. Components of system 100, for example, communication module 110, calculation module 120, storage module 130, and user access points 140, may be communicatively coupled by network 150. In certain embodiments, any component of system 100 can communicate with one or more other components of system 100.

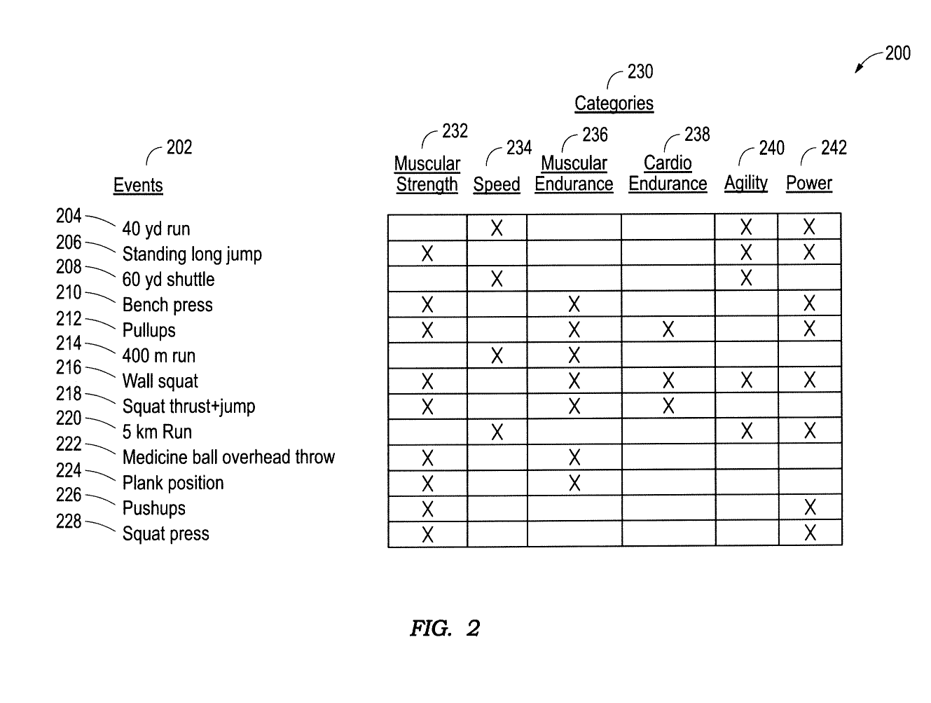

Communication module 110 represents a component of system 100 operable to communicate information to, and/or receive information from, user access points 140. In certain embodiments, communication module 110 includes one or more of processor 112, interface 114, memory 116, and database 118. Communication module 110 may be operable to provide user access points 140 instructional information related to executing particular athletic events and measuring event performance. In an embodiment, communication module 110 is operable to receive athletic event performance measurements from user access points 140. Athletic event performance measurements represent a performance measurement for an athletic event (e.g., time, distance, weight, or other suitable metric). In an embodiment, athletic event scores are unscaled and represent actual measurements of athletic event performance. Athletic event selection, execution, and measurement will be discussed in more detail below with respect to FIG. 2. Event performance measurements may be determined by users from the information provided by communication module 110. Communication module 110 may communicate received event performance measurements to calculation module 120 and/or store received event performance measurements in storage module 130. In an embodiment, communication module 110 supports a website, or other suitable network communication platform. The website may provide an interface between user access points 140 and communication module 110.

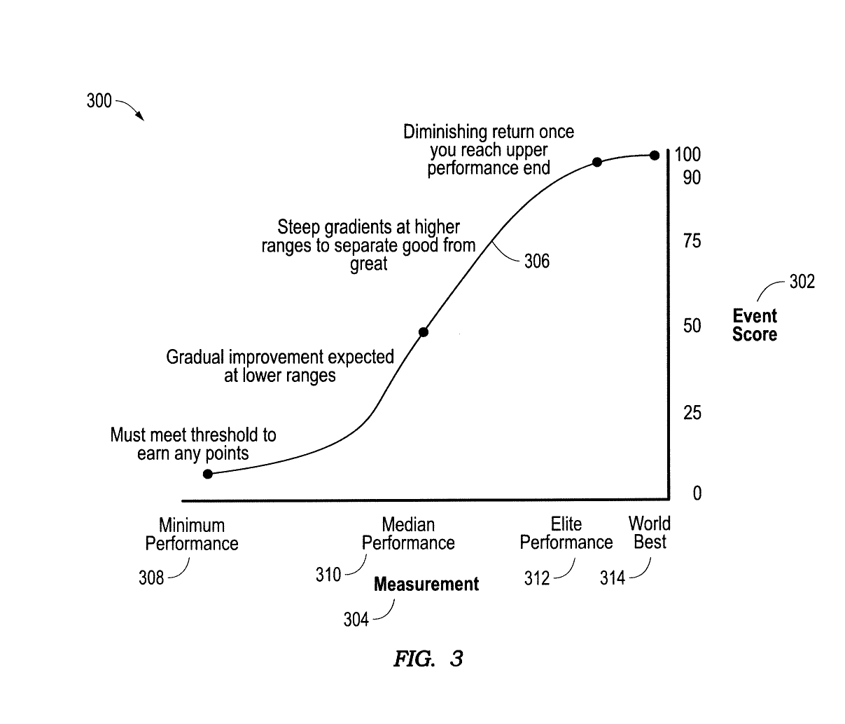

Calculation module 120 represents a component of system 100 operable to perform calculations for system 100. In certain embodiments, calculation module 120 includes one or more of processor 122, interface 124, memory 126, and database 128. Calculation module 120 may determine event performance scores from event performance measurements. For example, calculation module 120 may determine that an event performance measurement of 4.82 seconds for the 40 yard run has an event performance score of 75 points out of a possible 100 points. In an embodiment, the determination of an event performance score from an event performance measurement is based on a non-linear performance scale (i.e., the relationship between event performance measurement and event performance score is non-linear). Performance scales will be discussed in more detail below with respect to FIG. 3.

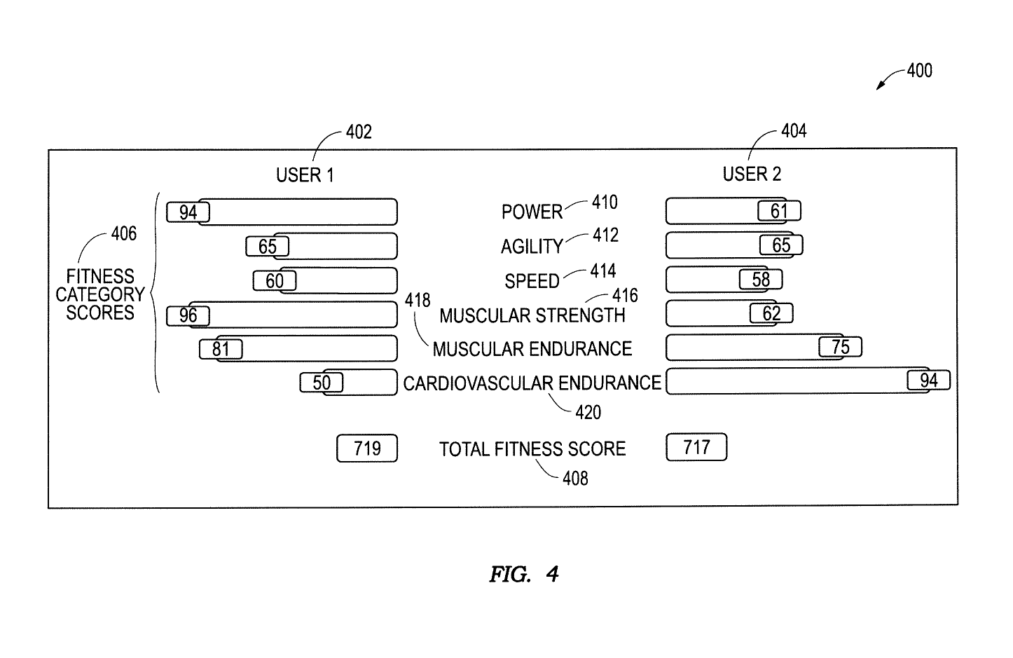

Each athletic event may be associated with one or more fitness categories (e.g., muscular strength, muscular endurance, cardiovascular endurance, speed, agility, power, core, flexibility, or any other suitable classification of athletic event). Fitness categories will be discussed in more detail below with respect to FIG. 2. In an embodiment, calculation module 120 calculates one or more fitness category scores based on the determined event performance scores. Certain athletic events may be weighted heavier than others in determining a fitness category score. For example, a fitness category associated with three athletic events may weight the first event as 50% of the fitness category score, the second event as 35% of the fitness category score, and the third event as 15% of the fitness category score. Calculation of fitness category scores will be discussed in more detail below with respect to FIG. 4.

Calculation module 120 may calculate a total fitness score for a user. In an embodiment, the total fitness score for a user is based on the calculated fitness category scores. The total fitness score provides a metric to compare a user's fitness level to other users, to athletes with different athletic specialties (e.g., comparing a marathon runner to an Olympic weight lifter), and to world class athletes (event performance scores may be based, at least in part, on world record performances in the event). The total fitness score may be indicative of overall health and/or future health. In certain embodiments, the total fitness score and/or fitness category scores are used to evaluate health, for example, for the purpose of assessing health insurance risk. In certain embodiments, the total fitness score and/or fitness category scores are used to evaluate fitness, for example, by athletic teams, branches of a military, fire fighting departments, police departments, or any other suitable industry. The total fitness score will be discussed in more detail below with respect to FIG. 4.

Storage module 130 represents a component of system 100 operable to store information. In certain embodiments, storage module 130 includes one or more of processor 132, interface 134, memory 136, and database 138. Storage module 130 may store event performance measurements, event performance scores, fitness category scores, total fitness scores, performance scales, or any other suitable information for system 100. In certain embodiments, storage module 130 stores event performance measurements, event performance scores, fitness category scores, total fitness scores, performance scales, or any other suitable information associated with particular users, classes of users (e.g., gender, age, or other classification of users), dates, locations, or any other suitable information.

User access points 140 represent a component of system 100 operable to access network 150 to communicate with communication module 110. User access points 140 include any suitable electronic communication device operable to access an electronic communication network (e.g., computers, smart phones, tablets, etc.). In certain embodiments, user access points 140 include certified user access points 140. Certified user access points 140 represent user access points 140 that are associated with particular classes of users. For example, a user that has been specially trained in proper execution of athletic events can be authenticated by system 100 and the user access point 140 associated with the authenticated user can become a certified user access point 140. Certified user access points 140 allow system 100 to distinguish between athletic event measurements communicated by general users and those communicated by certified users. Measurements communicated by certified users may be more trustworthy and accurate than those communicated by general users. Certified user measurements may be used for competitions, by employers, insurance companies, or other entities that may require higher levels of trustworthiness and accuracy than a general user.

Network 150 represents any suitable network operable to facilitate communication between components of system 100, such as communication module 110, calculation module 120, storage module 130, and user access points 140. Network 150 may include any interconnecting system capable of transmitting audio, video, electrical signals, optical signals, data, messages, or any combination of the preceding. Network 150 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

A module (e.g., communication module 110, calculation module 120, and storage module 130) may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of a module may be performed by any suitable combination of one or more servers or other components at one or more locations. In embodiments where modules represent a server, the server may be a private server, and the server may be a virtual or physical server. Additionally, a module may include any suitable component that functions as a server.

Components of system 100, such as communication module 110, calculation module 120, storage module 130, and user access points 140, may include one or more processors. A processor represents any computing device, such as processors 112, 122, 132, and 142, configured to control the operation of one or more components of system 100. A processor may comprise one or more processors and may be a programmable logic device, a microcontroller, a microprocessor, any suitable processing device, or any suitable combination of the preceding. A processor includes any hardware or software that operates to control and process information received by a component of system 100. In certain embodiments, a processor communicatively couples to other components of system 100, such as a module (e.g., calculation module 11 and storage modules 140), an interface (e.g., interfaces 114, 124, 134, and 144), a memory (e.g., memories 116, 126, 136, and 146), a database (e.g., databases 118, 128, 138, and 148), or any other suitable component.

An interface represents any device, such as interfaces 114, 124, 134, and 144, operable to receive input, send output, process the input or output, or perform other suitable operations for a component of system 100. An interface includes any port or connection, real or virtual, including any suitable hardware or software, including protocol conversion and data processing capabilities, to communicate through network 150. In certain embodiments, an interface includes a user interface (e.g., physical input, graphical user interface, touchscreen, buttons, switches, transducer, or any other suitable method to receive input from a user).

A memory represents any device, such as memories 116, 126, 136, and 146, operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 118, 128, 138, and 148).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of components.

Modifications, additions, or omissions may be made to system 100. System 100 may include more, fewer, or other components. Any suitable component of system 100 may include a processor, interface, logic, memory, or other suitable element. Any component of system 100 may be communicatively coupled to any other component of system 100 through network 150.

FIG. 2 is a chart 200 of an example embodiment of athletic events 202 and corresponding fitness categories 230. Athletic events 202 include 40 yard run 204, standing long jump 206, 60 yard shuttle run 208, bench press 210, pullups 212, 400 meter run 214, wall squat 216, squat thrust and jump (burpee) 218, 5 kilometer run 220, medicine ball overhead throw 222, plank position hold 224, pushups 226, squat press 228, or any other suitable athletic event. Suitable athletic events include events with low risk of injury, events that are commonly known or simple to learn and execute, events that utilize commonly available apparatuses (e.g., bench presses, squat presses, tracks, etc.), and events that are easily measured (e.g., distance, time, weight, repetitions, etc.).

Forty yard run 204 represents a timed sprint of 40 yards. Standing long jump 206 represents a jump for maximum horizontal distance from a stationary standing position. Sixty yard shuttle run 208 represents a timed shuttle sprint to distances of 5 yards, 10 yards, and 15 yards. Using a football field as an example, the measurement of the 60 yard shuttle run 208 would be the total time for a user to run from the goal line to the 5 yard line, back to the goal line, to the 10 yard line, back to the goal line, to the 15 yard line, and finally back to the goal line. In certain embodiments, a user must touch the ground or pick up an object each time the user changes direction (e.g. at the 5 yard line, the goal line, the 10 yard line, the goal line, the 15 yard line, and the goal line).

Bench press 210 represents the maximum amount of weight a user can bench press. In certain embodiments, a user must hold the weight on their chest for a predetermined amount of time before completing the bench press 210. In certain embodiments bench press 210 represents the maximum number of repetitions at a predetermined weight or a projected 1 repetition maximum weight based on the number of repetitions completed for a particular weight. Pullups 212 represent the maximum number of pullups 212 a user can complete without letting go of a pull-up bar. In certain embodiments, pullups 212 represent dead hang pullups where the user cannot swing. Pullups 212 may require the user to bring some part of their body to contact the bar or rise above the bar (e.g., head, eyes, chin, chest). Four hundred meter run 214 represents a timed spring of 400 meters. Wall squat 216 represents a timed wall squat where a user squats in a seated position against a wall. Squat thrust and jump (burpee) 218 represents the maximum number of times a user can complete the squat thrust and jump movement in a particular time period (e.g., 2 minutes). In an embodiment, the squat thrust and jump movement is where a user starts in a standing position, moves to a face down position with their chest touching the ground, stands up, and jumps. In certain embodiments, there is a minimum height to jump (e.g., an object a predetermined height that a user must touch on each jump). Five kilometer run 220 represents a timed run of 5 kilometers.

Medicine ball overhead throw 222 represents the maximum distance a user can throw a medicine ball from a stationary standing position, bringing the ball over the top of the head, and then throwing the ball forward with both hands on the ball throughout the throwing motion. In certain embodiments, the medicine ball is an 8 lb. medicine ball. Plank position hold 224 represents the maximum amount of time a user can hold the plank position where the user is facing the ground on their toes and forearms with their body held rigid and straight. Pushups 226 represent the maximum number of pushups 226 a user can complete without leaving the pushup position. In certain embodiments, a user must touch their chest to the ground to complete a repetition. Squat press 228 represents the maximum amount of weight a user can squat press. In certain embodiments, squat press 228 is performed with a barbell and free weights.

Fitness categories 230 include muscular strength category 232, speed category 234, muscular endurance category 236, cardiovascular endurance category 238, agility category 240, and power category 242. Each category 230 includes one or more athletic events 202. Fitness category scores are based on performance scores from the athletic events 202 included within each category 230. In an embodiment, the weight the included athletic events 202 have on the fitness category 230 score can be different. For example, a fitness category 230 associated with three athletic events 202 may weight the first event as 50% of the fitness category score, the second event as 35% of the fitness category score, and the third event as 15% of the fitness category score.

Muscular strength category 232 includes events that rely on muscle strength (e.g., the ability to generate force against resistance), for example, standing long jump 206, bench press 210, pullups 212, wall squat 216, squat thrust and jump 218, medicine ball overhead throw 222, plank position hold 224, pushups 226, and squat press 228. Muscular strength category 232 may include any other suitable athletic event that depends heavily on muscle strength.

Speed category 234 includes events that rely on speed (e.g., the ability to run quickly over distances), for example, 40 yard run 204, 60 yard shuttle run 208, 400 meter run 214, and 5 kilometer run 220. Speed category 232 may include any other suitable athletic event that depends heavily on speed.

Muscular endurance category 236 includes events that rely on muscular endurance (e.g., the ability to maintain strength over a period of exertion), for example, pullups 212, 400 meter run 214, wall squat 216, squat thrust and jump 218, 5 kilometer run 220, plank position 224, and pushups 226. Muscular endurance category 236 may include any other suitable athletic event that depends heavily on muscular endurance.

Cardiovascular endurance category 238 includes events that rely on cardiovascular endurance (e.g., the ability to sustain cardiovascular effort over a long period of time), for example, 400 meter run 214, squat thrust and jump 218, and 5 kilometer run 220. Cardiovascular endurance category 238 may include any other suitable athletic event that depends heavily on cardiovascular endurance.

Agility category 240 includes events that rely on agility (e.g., the ability to move quickly and change direction), for example, 40 yard dash 204, standing long jump 206, 60 yard shuttle run 208, squat thrust and jump 218, and medicine ball overhead throw 222. Agility category 240 may include any other suitable athletic event that depends heavily on agility.

Power category 242 includes events that rely on power (e.g., the ability to generate energy in short time periods), for example, 40 yard run 204, standing long jump 206, bench press 210, pullups 212, squat thrust and jump 218, medicine ball overhead throw 222, pushups 226, and squat press 228. Power category 242 may include any other suitable athletic event that depends heavily on agility.

Modifications, additions, or omissions may be made to chart 200. Chart 200 may include more, fewer, or other rows, columns, cells, athletic events 202, fitness categories 230, or other suitable information. The listed athletic events and fitness categories are examples and other similar athletic events, fitness categories, or variations (e.g., variations in distance, weight, repetitions, or technique) of the preceding are included within the scope of this disclosure. For example, additional or substitute fitness categories may include core strength, flexibility, or any other suitable physical attribute. Fitness categories may include more, fewer, or other athletic events (e.g., swimming, cycling, rowing, etc. In certain embodiments, the number and type of athletic events are determined by a user. For example, an employer or health insurance provider may select a set of events (e.g., a subset of events 202) to use to evaluate employees or customers.

FIG. 3 is a graph 300 of an example embodiment of a performance scale for converting event performance measurements to event performance scores. Graph 300 may be displayed to a user of user access point 140. Graph 300 includes event score axis 302, measurement axis 304, and scale line 306. Event score axis 302 represents the converted event score, measurement axis 304 represents the event performance measurement, and scale line 306 represents the converted event score 302 for a particular event measurement 304. In an embodiment, event performance score axis 302 converts event performance measurements to scores between 0 and 100. In the illustrated embodiment, an event measurement 304 must exceed minimum threshold 308 to convert to a non-zero event score 302. Minimum threshold 308 may represent a minimum number of repetitions (e.g., 1), a minimum weight, or maximum time for a particular event. In an embodiment, scale 306 gradually increases in slope at low performance levels and then sharply increases in slope at median performance level 310. Median performance level 310 represents a median score for an event, for example, based on a sample of user event performance measurements. Scale 306 decreases in slope at elite performance level 312. Elite performance level 312 represents high performance level for an event (e.g., top 10% of scores or other suitable metric). Scale 306 reaches its maximum at world best level 314. World best level 314 represents the maximum recorded score for an event, and enables users to compare themselves to world class athletes.

An event may have a number of different performance scales 306, for example, for different user genders, user ages, user experience levels, user disabilities, user professions, user fitness levels, user insurance provider, user employer, user sport or activity, or any other suitable differentiation. In certain embodiments, performance scale 306 may be based on received event measurements and calculation module 120 may update the performance scale based on received event performance measurements. For example, calculation module 120 receives criteria for a performance scale (e.g., an equation describing a scale) with one or more of minimum performance level 308, median performance level 310, elite performance level 312, and world best performance level 314 as inputs. Calculation module 120 may receive minimum performance level 308 and world best performance level 314 as inputs, and determine median performance level 310 and elite performance level 312 from received event performance scores. In this way, performance scale 306 can adjust in response to additional data.

Modifications, additions, or omissions may be made to chart 300. Chart 300 may include a different scale 306 and different performance levels. Scale 306 may be different for different events, different user categories (e.g., age groups, gender, ability level, etc.).

FIG. 4 is a diagram 400 illustrating an example embodiment of fitness category scores 406 and total fitness scores 408 for two different types of athlete. Graph 400 may be displayed to a user of user access point 140. In the illustrated embodiment, User 1 402 represents a user with a proficiency in weight lifting and User 2 404 represents a user with a proficiency in distance running. It is difficult to compare User 1 and User 2 because their athletic profiles are very different. However, by determining a total fitness score 408 for User 1 and User 2, a comparison is possible. In the illustrated embodiment, User 1 402 has a power category 410 score of 94, an agility category 412 score of 65, a speed category 414 score of 60, a muscular strength category 416 score of 81, a muscular endurance category 418 score of 75, and a cardiovascular endurance category 420 score of 50. The resulting total fitness score for User 1 is 719. User 2 404 has a power category 410 score of 61, an agility category 412 score of 65, a speed category 414 score of 58, a muscular strength category 416 score of 62, a muscular endurance category 418 score of 75, and a cardiovascular endurance category 420 score of 94. The resulting total fitness score for User 2 is 717. Accordingly, User 1 and User 2 have comparable total fitness levels.

Modifications, additions, or omissions may be made to diagram 400. Diagram 400 may include more, fewer or other fitness categories and/or athletic types. The conversion scale for determining total fitness score 408 may be different, and may be based on user gender, age, ability, or other criteria.

Certain embodiments of the present disclosure may include some, all, or none of the following advantages. One or more other technical advantages may be readily apparent to those skilled in the art from the figures, descriptions, and claims included herein.

In an embodiment, a system for evaluating a fitness level allows users to determine a fitness level using an electronic communication network, thereby reducing the time and cost required to determine a fitness level.

In an embodiment, a system for evaluating a fitness level automatically updates performance scales based on event performance data received from users, thereby reducing the bandwidth, memory, and computing resources consumed by manually researching event performance data and manually updating performance scales.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A non-transitory computer-readable medium comprising logic for evaluating a fitness level, the logic, when executed by a processor, operable to:
receive an event performance measurement for each of a plurality of athletic events, wherein the events comprise at least a timed 400 meter run, a timed 40 yard run, a timed 5 kilometer run, a timed 60 yard shuttle run, a maximum number of squat thrust and jump in a time period, a measured standing broad jump distance, a measured overhead medicine ball throw distance, a maximum number of pushups, a maximum bench press weight, a maximum time plank position hold, a maximum number of pullups, a maximum squat press weight, and a maximum time wall squat;
determine an event performance score for each received event performance measurement;
associate one or more fitness categories with each of the plurality of athletic events, wherein the fitness categories comprise power, agility, speed, muscular strength, muscular endurance, and cardiovascular endurance;
calculate a fitness category score for each of the plurality of fitness categories, wherein each fitness category score is based on one or more of the event performance scores;
calculate a total fitness score based on the calculated fitness category scores; and
communicate the calculated total fitness score over an electronic communication network.

2. The computer readable medium of claim 1, the logic further operable to:
determine a non-linear performance scale for each of the athletic events, wherein the performance scale is based on a minimum measurement for each athletic event and a maximum measurement for each athletic event, the maximum measurement based at least in part on a maximum recorded measurement for the athletic event; and
adjusting the performance scale based on received event performance measurements.

3. A system for evaluating a fitness level, comprising:
an electronic interface operable to receive an event performance measurement for each of a plurality of athletic events;
a processor communicatively coupled to the electronic interface and operable to:
associate one or more fitness categories with each of the plurality of athletic events;
determine an event performance score for each received event performance measurement;
calculate a fitness category score for each of the plurality of fitness categories, wherein each fitness category score is based on one or more of the event performance scores; and
calculate a total fitness score based on the calculated fitness category scores; and
the electronic interface further operable to communicate the calculated total fitness score over an electronic communication network.

4. The system of claim 3, wherein the fitness categories include one or more from the set comprising: power, agility, speed, muscular strength, muscular endurance, and cardiovascular endurance.

5. The system of claim 3, wherein the athletic events include one or more of: a timed 400 meter run, a timed 40 yard run, a timed 5 kilometer run, a timed 60 yard shuttle run, a maximum number of squat thrust and jump in a time period, a measured standing broad jump distance, a measured overhead medicine ball throw distance, a maximum number of pushups, a maximum bench press weight, a maximum time plank position hold, a maximum number of pullups, a maximum squat press weight, and a maximum time wall squat.

6. The system of claim 3, wherein an athletic event is associated with at least one of a plurality of fitness categories.

7. The system of claim 3, the processor further operable to determine a non-linear performance scale for each of the athletic events, wherein the performance scale is based on a minimum measurement for each event and a maximum measurement for each athletic event, the maximum score based at least in part on maximum recorded measurement for the event.

8. The system of claim 7, the processor further operable to adjust the performance scale based on received event performance measurements

9. A non-transitory computer-readable medium comprising logic for evaluating a fitness level, the logic, when executed by a processor, operable to:
receive an event performance measurement for each of a plurality of athletic events;
determine an event performance score for each received event performance measurement;
associate one or more fitness categories with each of the plurality of athletic events;
calculate a fitness category score for each of the plurality of fitness categories, wherein each fitness category score is based on one or more of the event performance scores;
calculate a total fitness score based on the calculated fitness category scores; and
communicate the calculated total fitness score over an electronic communication network.

10. The computer-readable medium of claim 9, wherein the fitness categories include one or more from the set comprising: power, agility, speed, muscular strength, muscular endurance, and cardiovascular endurance.

11. The computer-readable medium of claim 9, wherein the athletic events include one or more of: a timed 400 meter run, a timed 40 yard run, a timed 5 kilometer run, a timed 60 yard shuttle run, a maximum number of squat thrust and jump in a time period, a measured standing broad jump distance, a measured overhead medicine ball throw distance, a maximum number of pushups, a maximum bench press weight, a maximum time plank position hold, a maximum number of pullups, a maximum squat press weight, and a maximum time wall squat.

12. The computer-readable medium of claim 9, wherein an athletic event is associated with at least one of a plurality of fitness categories.

13. The computer-readable medium of claim 9, the logic further operable to determine a non-linear performance scale for each of the athletic events, wherein the performance scale is based on a minimum measurement for each event and a maximum measurement for each athletic event, the maximum measurement based at least in part on maximum recorded measurement for the event.

14. The computer-readable medium of claim 9, the logic further operable to adjust the performance scale based on received event performance measurements.

15. A method for evaluating a fitness level, comprising
receiving, through an electronic interface, an event performance measurement for each of a plurality of athletic events;
determining an event performance score for each received event performance measurement;
associating one or more fitness categories with each of the plurality of athletic events;
calculating, by a processor communicatively coupled to the electronic interface, a fitness category score for each of the plurality of fitness categories, wherein each fitness category score is based on one or more of the event performance scores;
calculating, by the processor, a total fitness score based on the calculated fitness category scores; and
communicating, by the electronic interface, the calculated total fitness score over an electronic communication network.

16. The method of claim 15, wherein the fitness categories include one or more from the set comprising: power, agility, speed, muscular strength, muscular endurance, and cardiovascular endurance.

17. The method of claim 15, wherein the athletic events include one or more of: a timed 400 meter run, a timed 40 yard run, a timed 5 kilometer run, a timed 60 yard shuttle run, a maximum number of squat thrust and jump in a time period, a measured standing broad jump distance, a measured overhead medicine ball throw distance, a maximum number of pushups, a maximum bench press weight, a maximum time plank position hold, a maximum number of pullups, a maximum squat press weight, and a maximum time wall squat.

18. The method of claim 15, wherein an athletic event is associated with at least one of a plurality of fitness categories.

19. The method of claim 15, further comprising determining a non-linear performance scale for each of the athletic events, wherein the performance scale is based on a minimum measurement for each event and a maximum measurement for each athletic event, the maximum measurement based at least in part on maximum recorded measurement for the event.

20. The method of claim 19, further comprising adjusting the performance scale based on received event performance measurements.
